(19) United States
(12) Patent Application Publication
(10) Pub. No.: US 2013/0032082 A1
(43) Pub. Date: Feb. 7, 2013

(54) AREA PROTECTION SYSTEM

(71) Applicant: Maurice Peyton Penick, Vilas, NC (US)

(72) Inventor: Maurice Peyton Penick, Vilas, NC (US)

(21) Appl. No.: 13/567,080

(22) Filed: Aug. 5, 2012

Related U.S. Application Data
(60) Provisional application No. 61/574,438, filed on Aug. 4, 2011.

(51) Int. Cl. G10K 9/20

(52) U.S. Cl. 116/143

(57) ABSTRACT

An area protection system deters predators/varmint from specific areas, such as vegetable gardens, shrubs, flower beds and the like. The system includes a horn that sounds an alert when the predator/varmint pulls a trip wire that circumscribes the area where protection is desired. The system does not use harmful chemicals or electric shock and does not require an electricity supply or batteries. The system is simple to set-up and maintain. The system can be set up in straight runs, circles, squares, and up and down elevations, making the system versatile.

### CROSS-REFERENCE TO RELATED APPLICATION

This application claims the benefit of priority of U.S. provisional application No. 61/574,438, filed Aug. 4, 2011, the contents of which are herein incorporated by reference.

### BACKGROUND OF THE INVENTION

The present invention relates to an area protection system and, more particularly, to an area protection system for deterring predators/varmint from vegetable gardens, shrubs and flower beds.

Predators, such as deer, raccoons, dogs, and the like, enter unprotected premises and eat or destroy vegetables, flowers, shrubs and the like.

Conventional systems costly and difficult to set up for the user and can potentially harm or kill predators upon exposure to electrical shock or chemical-based systems. Many people are concerned about chemical-based deterring systems and the impact upon vegetation. Also, many people are very disturbed about the potential harm caused by electrical shock systems. Moreover, having to construct a costly, unsightly tall fence to protect an area is not practical for many people.

As can be seen, there is a need for an improved system for protecting an area from predators/varmint while avoiding the use of chemicals and electric shock. There is a further need for an easy to install kit for deploying an area protection system.

### SUMMARY OF THE INVENTION

In one aspect of the present invention, a area protection system comprises a horn unit positioned on a horn mounting post; one or more line pass stake units disposed about a perimeter of an area to be protected; a solid mount stake unit disposed at a position opposite the horn unit along a perimeter of the area to be protected; and a first line running from the horn unit, through the line pass stake units, and terminating at the solid mount stake unit, wherein a pressure applied to the line causes a horn in the horn unit to sound.

In another aspect of the present invention, a area protection system comprises a horn unit positioned on a horn mounting post; a lever, in the horn unit, movable between a first position, where a trigger is disengaged from a horn button, and a second position, where the trigger is engaged and depressing the horn button; one or more line pass stake units disposed about a perimeter of an area to be protected; a solid mount stake unit disposed at a position opposite the horn unit along a perimeter of the area to be protected; a first line running from the horn unit in a first direction, through the line pass stake units, and terminating at the solid mount stake unit; and a second line running from the horn unit in a second direction, different from the first direction of the first line, and terminating at the solid mount stake unit, wherein a pressure applied to the line causes the lever to move to the second position, causing a horn to sound.

These and other features, aspects and advantages of the present invention will become better understood with reference to the following drawings, description and claims.

### BRIEF DESCRIPTION OF THE DRAWINGS

FIG. 1 is a perspective view of an area protection system being triggered by a predator, according to an exemplary embodiment of the present invention;

FIG. 2 is a plan view of an area protected by an exemplary installation configuration of the area protection system of the present invention;

FIG. 3 is a detailed perspective view of an eye bolt secured to a mounting post and guiding a trip line of the area protection system of the present invention;

FIG. 4 is a detailed perspective view of an eye bolt securing a trip line to a mounting post;

FIG. 5 is a side detail view of a horn unit of the area protection system of the present invention is a stand-by state; and

FIG. 6 is a side detail view of the horn unit of FIG. 5, with the horn unit in an activated state.

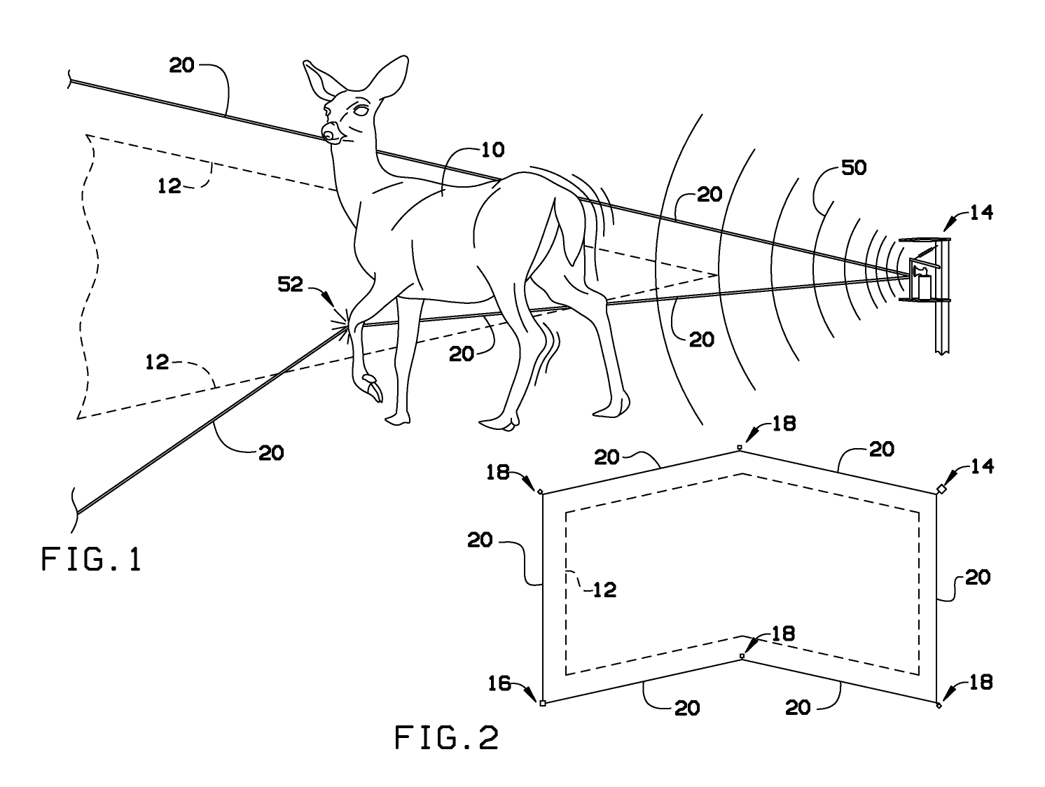

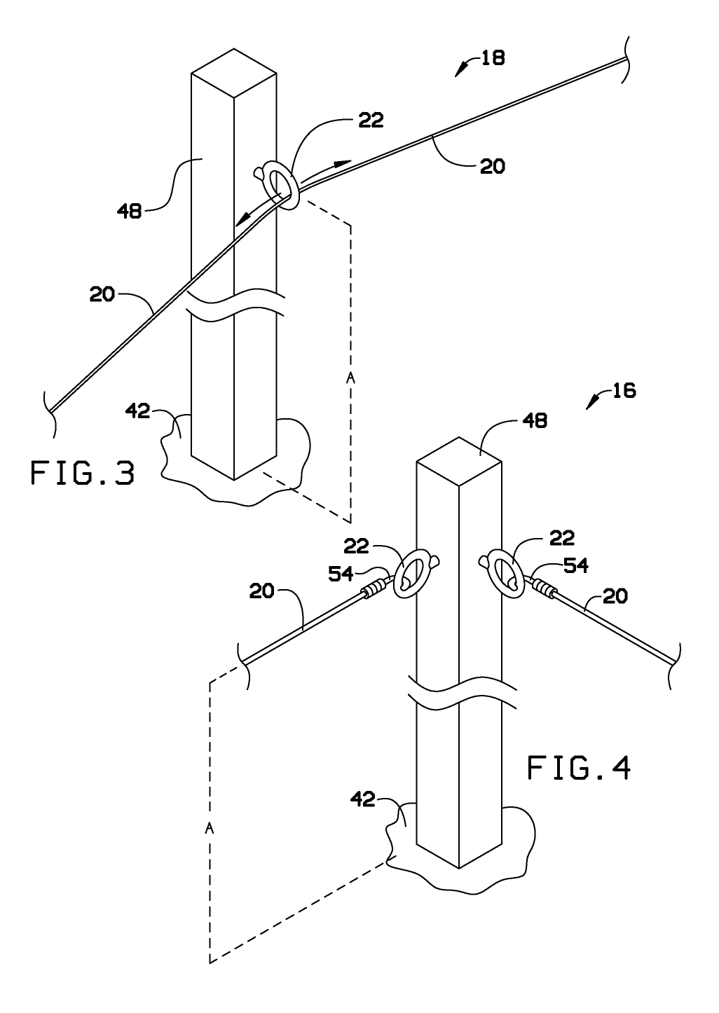

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an area protection system for deterring predators/varmint from specific areas, such as vegetable gardens, shrubs, flower beds and the like. The system includes a horn that sounds an alert when the predator/varmint pulls a trip wire that circumscribes the area where protection is desired. The system does not use harmful chemicals or electric shock and does not require an electricity supply or batteries. The system is simple to set-up and maintain. The system can be set up in straight runs, circles, squares, and up and down elevations, making the system versatile.

Referring now to the Figures, an area protection system can be designed to protect a desired area 12 from intruders 10, such as deer, raccoons, dogs, and the like. The area protection system includes a horn unit 14 triggered, as described below, by tension being placed on a line 20 that circumscribes the desired area 12. Typically, the line 20 will be disposed a pre-determined distance from the desired area 12 so that, for example, growth in the desired area 12 (such as a vegetable garden) does not grow near the line 20 and cause tension on the line 20.

The line 20 can include a first line that can run in a first direction, from the horn unit 14, about the desired area 12 to a solid mount stake unit 16, where the line 20 is secured. A second line can run from the horn unit 14, in a second direction, and be secured to the solid mount stake unit 16. Typically, the solid mount stake unit 16 is disposed at an opposite corner of the desired area 12 so that the first line and the second line are approximately the same length. FIG. 2 shows an example of this layout configuration. In some embodiments, for example, where a fence is already in place, the line 20 may be a single line running from the horn unit 14 placed at one part of the fence to the solid mount stake unit at another portion of a fence, where the line, in addition to the fence, enclosed the desired area 12. In some embodiments, the horn unit 14 can be centrally positioned and the two solid mount stake units could terminate at two different locations, for example, at a fence, to enclose a desired area.

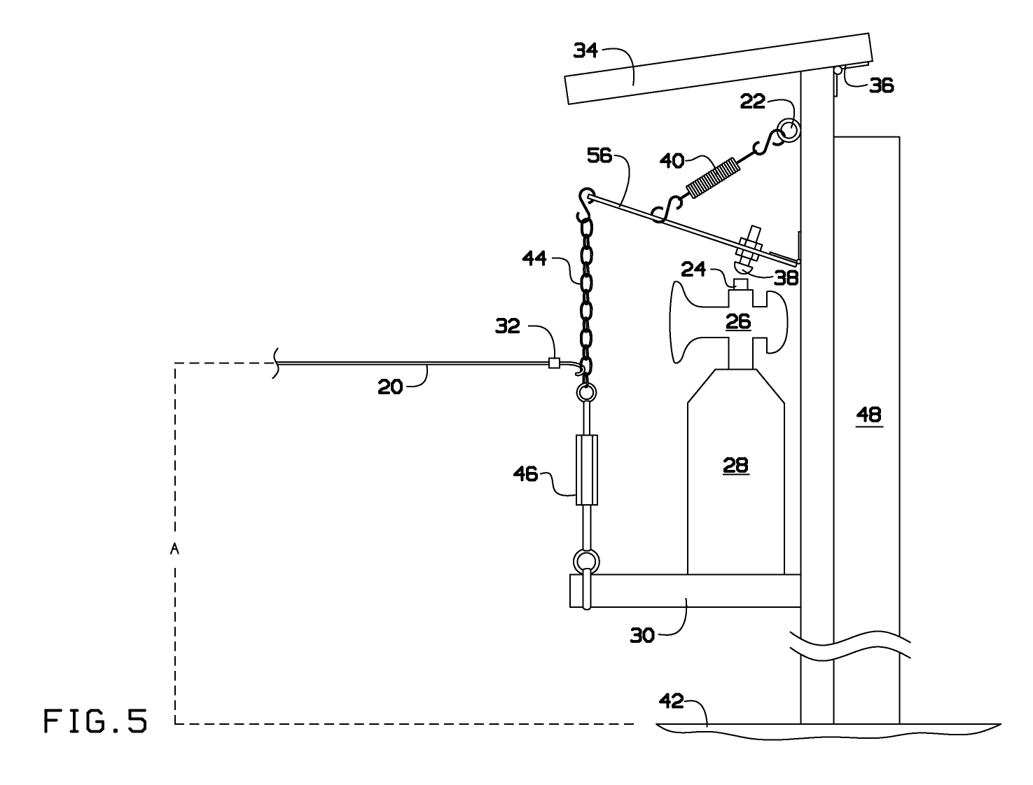

The solid mount stake unit 16 can include a mounting post 48 having one or more eye bolts 22 attached thereto, where the line 20 can be secured. In some embodiments, a line hook 54 can be disposed on the end of the line and the line hook 54 can attach to the eye bolts 22, as shown in FIG. 4. Typically, the line hook 54 is bent, but not hooked together. This feature allows the line hook 54 to straighten and come out of the eye bolt 22 should an animal pull hard on the line 20 or get caught on the line, for example. The user can simply reattach and re-bend the line hook 54 to “re-arm” the protection system.

To help guide the line 20 about the desired area 12, one or more line pass through units 18 can be disposed. The line 20 can pass through an eye bolt 22 secured to the mounting post 48 disposed in the ground 42.

In both the solid mount stake units 16 and the line pass through unit 18, the eye bolt 22 can be attached to the mounting post 48 at a certain distance from the ground 42. This distance may vary depending on the type of intruder one is looking to keep out of the desired area 12. For example, the eye bolts 22 can be about 18 inches above the ground for deer, about 8 inches above the ground for raccoon, and the like. In some embodiments, eye bolts 22 can be attached at multiple heights along the mounting post 48. In this embodiment, a line 20 could be run at two (or more) heights, where the system can then protect both from shorter intruders, such as raccoons, and larger intruders, such as deer.

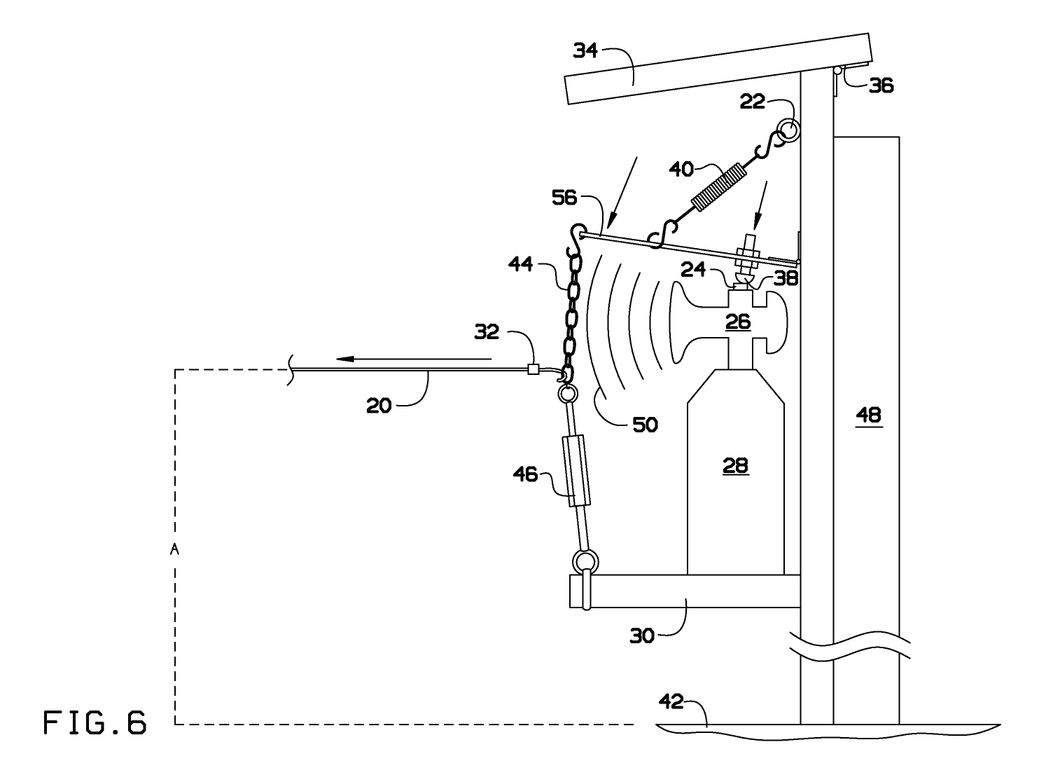

As shown in FIGS. 5 and 6, the horn unit 14 can be attached to a mounting post 48. A hood 34 can cover the horn unit 14 to protect it from nesting birds, harsh weather, and the like. The hood 34 can have a hinge 36 to permit easy access.

An air canister 28 can rest in a canister cup 30 that is mounted on the mounting post 48 (or, in some embodiments, may be resting on the ground 42). A horn 26 can be mounted on the air canister 28. The horn 26 can have an activation button 24 on a top portion thereof. Typically, the horn 26 can be pointed in a direction of the desired area 12 for protection to cause a sound wave 50 to scare away any intruders 10.

A lever hinge 56 can be pivotably moved between an unengaged position (FIG. 5), where a trigger bolt 38 is separated or not depressing on the horn button 24, and an engaged position (FIG. 6), where the trigger bolt 38 depressed the horn button 24, sounding the horn 26.

The lever hinge 56 can be held in the unengaged position with a tension spring 40. A chain 44 can extend from a distal end of the lever hinge 56 to connect with the canister cup 30 via a turn buckle 46. The turn buckle 46 can be adjusted so that the tension spring 40 only takes the lever hinge 56 into the unengaged position, but so that pulling on the chain 44 can cause the lever hinge 56 to move into the engaged position. The line 20 can connect to the chain 44 via a swivel hook 32, for example. When the line 20 is pulled, typically by an intruder, the line 20 pulls on the chain 44, causing the lever hinge 56 to move, where the trigger bolt 38 engages the horn button 24.

Various adjustments can be easily made to the horn unit 14. For example, the tension spring 40 can have various tension, or may be mounted at various positions to adjust its tension. The turn buckle 48 can be adjusted to change the amount of pull on the line 20 that is needed to activate the horn 28.

It should be understood, of course, that the foregoing relates to exemplary embodiments of the invention and that modifications may be made without departing from the spirit and scope of the invention as set forth in the following claims.

What is claimed is:

1. An area protection system comprising:
a horn unit positioned on a horn mounting post;
one or more line pass stake units disposed about a perimeter of an area to be protected;
a solid mount stake unit disposed at a position opposite the horn unit along a perimeter of the area to be protected; and
a first line running from the horn unit, through the line pass stake units, and terminating at the solid mount stake unit, wherein
a pressure applied to the line causes a horn in the horn unit to sound.

2. The area protection system of claim 1, further comprising a second line running from the horn unit in a second direction, different from a first direction of the first line, and terminating at the solid mount stake unit.

3. The area protection system of claim 1, wherein the line passes through eye bolts in the one or more line pass stake units, the eye bolts disposed at a desired height for an anticipated intruder.

4. The area protection system of claim 1, wherein the horn unit includes a lever movable between a first, disengaged position, where a trigger is disengaged from a horn button, and a second, engaged position, where the trigger is engaged and depressing the horn button.

5. The area protection system of claim 4, wherein the lever is held by a spring in the disengaged position.

6. The area protection system of claim 5, wherein a chain extends between a distal end of the lever and a canister cup, wherein pulling out on the chain moves the lever into the engaged position.

7. The area protection system of claim 6, wherein the line connects to the chain, wherein when an intruder causes a pressure to the line, the lever moves into the engaged position, sounding the horn.

8. An area protection system comprising:
a horn unit positioned on a horn mounting post;
a lever, in the horn unit, movable between a first position, where a trigger is disengaged from a horn button, and a second position, where the trigger is engaged and depressing the horn button
one or more line pass stake units disposed about a perimeter of an area to be protected;
a solid mount stake unit disposed at a position opposite the horn unit along a perimeter of the area to be protected;
a first line running from the horn unit in a first direction, through the line pass stake units, and terminating at the solid mount stake unit;
a second line running from the horn unit in a second direction, different from the first direction of the first line, and terminating at the solid mount stake unit, wherein
a pressure applied to the line causes the lever to move to the second position, causing a horn to sound.

9. The area protection system of claim 8, wherein the line passes through eye bolts in the one or more line pass stake units, the eye bolts disposed at a desired height for an anticipated intruder.

10. The area protection system of claim 8, further comprising:
a spring holding the lever in the disengaged position; and
a chain extending between a distal end of the lever and a canister cup, wherein pulling out on the chain moves the lever into the engaged position.
